(19) United States
(12) Patent Application Publication
(10) Pub. No.: US 2017/0093003 A1
(43) Pub. Date: Mar. 30, 2017

(54) POLARISATION-PRESERVING FILTER FOR A DUAL-POLARISED WAVEGUIDE

(71) Applicant: Airbus DS GmbH, Taufkirchen (DE)

(72) Inventors: Michael SCHNEIDER, Neubiberg (DE); Michael SZYMKIEWICZ, Zornedig (DE)

(21) Appl. No.: 15/270,683

(22) Filed: Sep. 20, 2016

(30) Foreign Application Priority Data
Sep. 24, 2015 (DE) 102015012401.3

(51) Int. Cl. H01P 1/207

(52) U.S. Cl. CPC H01P 1/207

(57) ABSTRACT

A polarisation-preserving filter for a dual-polarised waveguide with a basic body that is circular in cross section. Arranged in the interior of the basic body is a plurality of nubs, wherein the nubs are grouped in several rings, due to which a first, predetermined frequency band can be transmitted unobstructed and the transmission of a second, predetermined frequency band can be blocked.

### CROSS-REFERENCE TO RELATED APPLICATION

This application claims priority to German Patent Application No. 102015012401.3, filed Sep. 24, 2015, which is incorporated herein by reference in its entirety.

### TECHNICAL FIELD

The disclosed subject matter relates to a polarisation-preserving filter for a dual-polarised waveguide with a basic body that is circular in cross section.

### BACKGROUND

Filters in dual-polarised waveguides, which must not change the polarisation of a wave guided in the waveguide, must be executed in a circularly symmetrical manner. Circularly symmetrical waveguide steps are arranged in such a way that they form one or more cavity resonators coupled to one another. Alternatively, higher waveguide modes can be activated by circularly symmetrical waveguide steps, something which is described as a “cut-off resonator”. Due to the cavity resonators or cut-off resonators, however, the filter becomes very tolerance-sensitive. In particular, higher waveguide triodes are not adequately suppressed.

From US 2013/0342282 A1 and the publication “Novel designs of polarization-preserving circular waveguide filters” by Jens Bornemann and Seng Yong Yu in the International Journal of Microwave and Wireless Technologies, 2010, pages 531 to 536, it is known to use fluted filters in dual-polarised waveguides. The flutes used in this case are TM11 resonators. However, resonators that are coupled to one another are complex to design, sensitive to manufacturing tolerances and have a limited bandwidth on account of the resonant structures. Another disadvantage is that the TE21 mode is scarcely suppressed. This TE21 mode is often activated undesirably in dual-polarised waveguides and can pass the filter virtually unattenuated.

Alternatively, it is known to use TE111 resonators in such dual-polarised waveguides. However, the three-dimensional resonators used in this case have a large space requirement and must be manufactured very precisely to transmit the desired frequencies unobstructed and to suppress undesirable frequencies.

The aforementioned problems likewise arise in fluted or grooved filters with a square instead of a circular cross section. The modes TM11 and TE21 in a circular waveguide correspond to the TM21 and TE11 modes in a square waveguide.

In addition, other advantages, desirable features and characteristics will become apparent from the subsequent summary and detailed description, and the appended claims, taken in conjunction with the accompanying drawings and this background.

### SUMMARY

A disclosed feature of an embodiment of the invention is to specify a functionally improved polarisation-preserving filter for a dual-polarised waveguide, which filter has a low tolerance sensitivity and can be manufactured in a simple manner.

This is achieved by a filter according to the features of claim 1. Advantageous configurations result from the dependent claims.

A polarisation-preserving filter for a dual-polarised waveguide with a basic body that is circular in cross section is proposed, which is characterised in that the filter comprises a plurality of nubs, which are arranged in the interior of the basic body, wherein the nubs are grouped in several rings, whereby a first, predetermined frequency band can be transmitted unobstructed and the transmission of a second, predetermined frequency band can be blocked.

In contrast to the solutions known from the prior art, the polarisation-preserving filter thus uses not resonators, but nubs. The nubs may be present in different structural forms, as will become clear below.

The nubs are arranged in this case in such a way that the nubs are grouped in several rings. The rings are arranged concentrically with reference to an axis of the circular basic body. A circular basic body is understood in particular to mean a cylindrical basic body.

The nubs may have one or more of the following structural forms: the nubs may be formed as a cuboid and/or as a cylinder and/or as a hemisphere and/or as a hemiellipsoid, and/or as a prism and/or as a cone or truncated cone and/or as a pyramid or truncated pyramid or from combinations of different geometries. The polarisation-preserving filter in one configuration may have exclusively nubs of the same structural form. In another configuration, the polarisation-preserving filter may combine nubs of different structural forms. In this last-named variant, nubs of a first structural form may be distributed over one or more rings, for example. Nubs of at east one second structural form are then arranged on one or more other rings. Nubs of different structural forms may likewise be provided on one ring. Any combinations are generally possible.

The configuration of the polarisation-preserving filter may be such that the number of nubs per ring is identical. Thus, according to one embodiment, the adjacent nubs of the rings are arranged on one axis, which runs parallel to a longitudinal axis of the circular basic body. According to another configuration, the number of nubs per ring may be different.

The nubs in the polarisation-preserving filter may thus be distributed in such a way that all rings have an identical number of nubs. In another configuration, all rings may have a different number of nubs per ring respectively. Furthermore, another alternative is conceivable in which some of the rings have an identical number and another sub-number of the rings has a number of nubs different from this.

According to another configuration, it is provided that the dimensions of the nubs of a ring are identical in respect of their height and/or their lateral extension. In other words, it is provided according to this configuration that the dimensions of the nubs of a ring are identical in every spatial direction. Alternatively or in addition, it may be provided that the dimensions of the nubs of a ring are different in respect of their height and/or their lateral extension. According to this configuration, the nubs may have different dimensions only in respect of their height, for example. Other nubs can have different dimensions in respect of their lateral extensions. Combinations are also possible.

Here, too, different variants result, wherein according to one variant, one or more rings may have nubs with identical dimensions, while one or more rings different from these have nubs with other dimensions. Alternatively, the nubs assigned to one ring may also have different dimensions.

According to another configuration, the nubs may be distributed evenly over the circumference of a ring, so that the spacings and circumferential angles between two nubs have identical values. Alternatively, the nubs may be distributed differently over the circumference of a ring, so that the spacings between two nubs have different values.

Here, too, different alternatives are yielded. Thus a polarisation-preserving filter may be provided in which all nubs grouped in the several rings are distributed evenly over the circumference of a respective ring. In another configuration, the nubs grouped in several rings may be distributed differently over the circumference of one or more rings. Combinations with one another are also possible.

Another configuration provides that the spacings of the rings in an axial direction of the basic body are identical. Alternatively or in addition, the spacings of the rings in an axial direction of the circular basic body may also be different. This yields a plurality of different combinations. A polarisation-preserving filter is thus possible in which according to one variant all rings of the filter are spaced equidistantly from one another in an axial direction. In one alternative, the spacings of respectively adjacent rings may be different from one another. Another variant consists in a sub-number of the rings being arranged equidistantly from one another, while one or more other sub-numbers of rings have different spacings of respectively adjacent rings of nubs.

### BRIEF DESCRIPTION OF THE DRAWINGS

The various embodiments will hereinafter be described in conjunction with the following drawing figures, wherein like numerals denote like elements, and:

FIG. 1 shows a representation in perspective of a first configuration variant of a dual-polarised waveguide with a polarisation-preserving filter according to an embodiment of the invention;

FIG. 2 shows a front view of the waveguide from FIG. 1;

FIG. 3 shows a representation in perspective of a dual-polarised waveguide with a polarisation-preserving filter according to a second configuration variant;

FIG. 4 shows a lateral view of the waveguide from FIG. 3, wherein the arrangement of the nubs of the polarisation-preserving filter is visible to illustrate the construction of the polarisation-preserving filter;

FIG. 5 shows a front view of the waveguide from FIG. 3 with spherical nubs;

FIG. 6 shows a front view of a waveguide with lengthwise elliptical nubs of a polarisation-preserving filter according to an embodiment of the invention;

FIG. 7 shows a front view of a waveguide with cone-shaped nubs of a polarisation-preserving filter according to an embodiment of the invention;

FIG. 8 shows a front view of a waveguide with tetrahedron-shaped nubs of a polarisation-preserving filter according to an embodiment of the invention; and

FIG. 9 shows a front view of a waveguide with prism-shaped nubs of a polarisation-preserving filter according to an embodiment of the invention.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

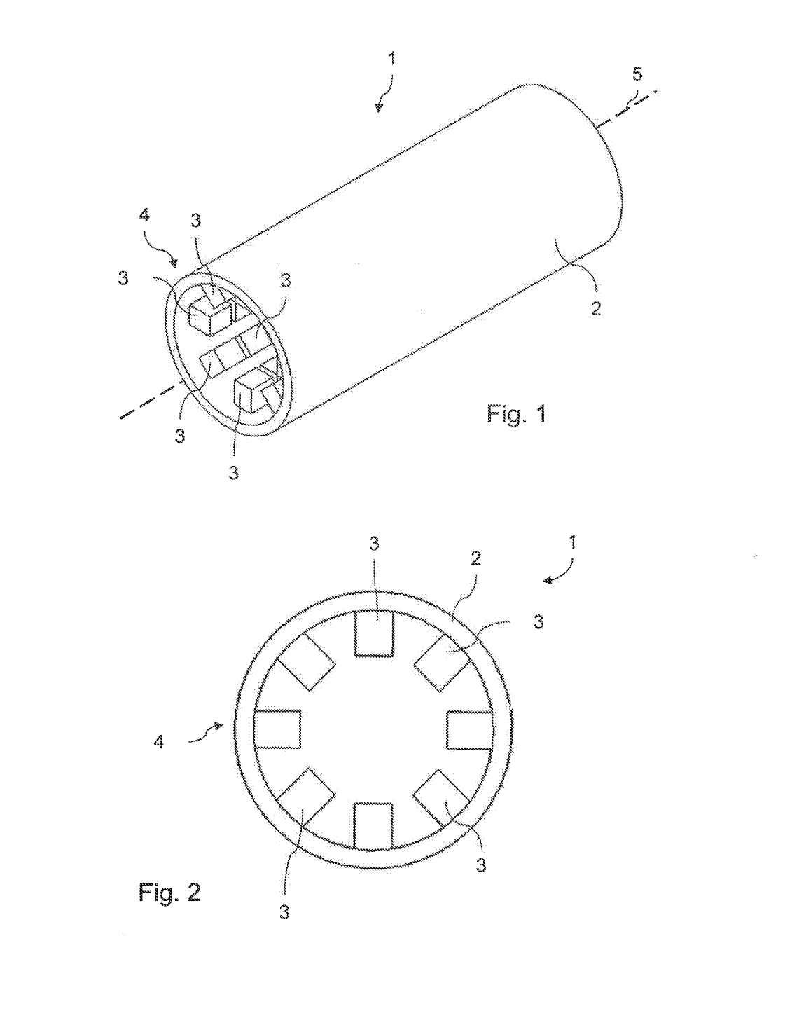

FIG. 1 shows in a representation in perspective a dual-polarised waveguide 1 with a basic body that is circular in cross section, i.e. cylindrical. In the interior of the basic body 2, a polarisation-preserving filter is arranged, which comprises a number of nubs 3, which are arranged in several rings 4 arranged coaxially with reference to a longitudinal axis 5. By way of example the nubs 3 in the polarisation-preserving filter shown in FIG. 1 have the form of a square.

As is evident from the front view in FIG. 2, for example, which shows the waveguide from the front, eight nubs 3 are arranged by way of example in a ring 4 and distributed evenly over the circumference of the ring 4. The nubs 3 are formed identically in this case with regard to their spatial dimensions in relation to an axial extension as well as a radial extension. In the variant illustrated in FIG. 2, it is further provided that the adjacent nubs 3 of adjacent rings 4 are arranged in one axis in each case, wherein the eight axes run parallel to the direction of the axial extension of the basic body 2.

In this as in all other practical examples, the nubs 3 extend from the circular wall of the basic body 2 in the direction of the centre of the cylindrical basic body 2. In the configuration variant shown in FIGS. 1 and 2, the nubs 3 are arranged in such a way that these lie opposite one another in pairs. Adjacent nubs are thus offset by an angle of 45° to one another.

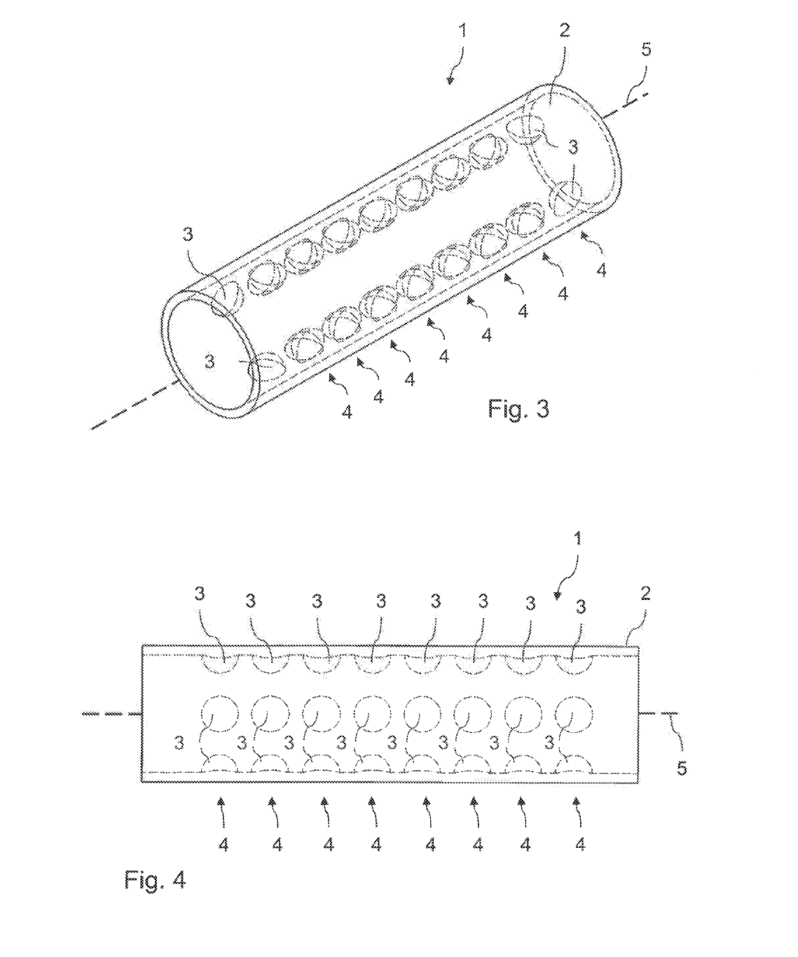

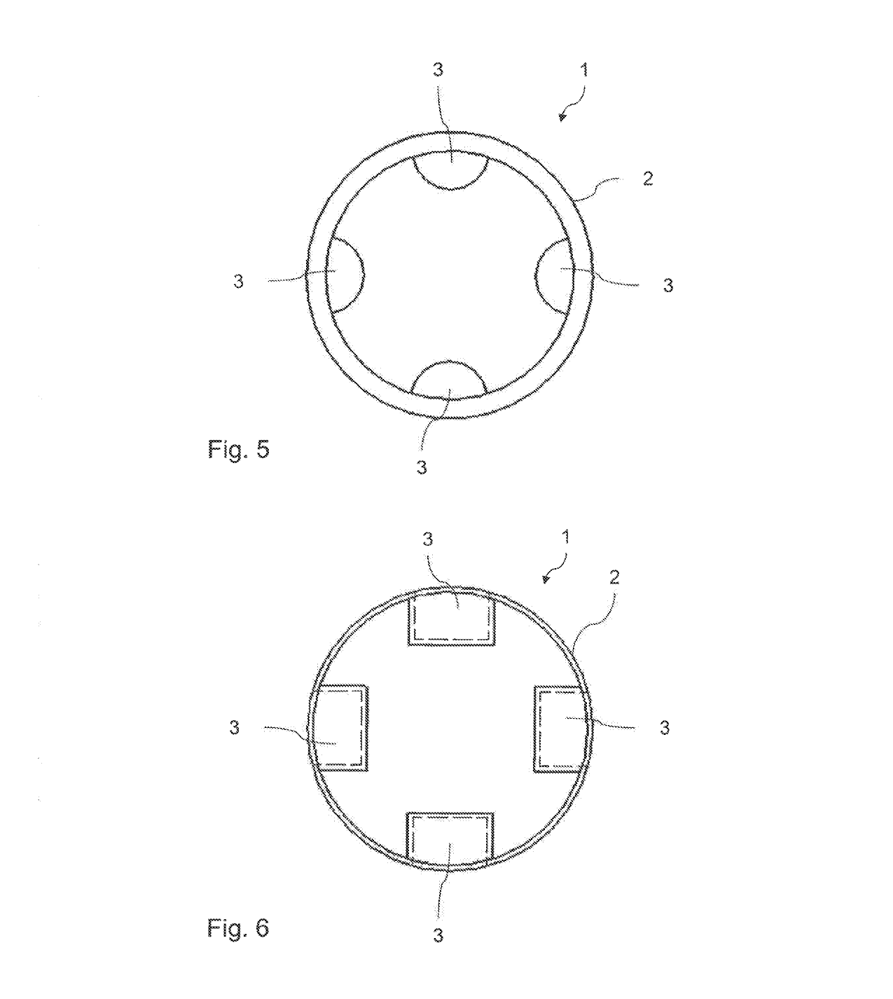

FIG. 3 shows a representation in perspective of a dual-polarised waveguide 1 with a polarisation-preserving filter according to a second configuration variant. In this configuration variant, the nubs are formed spherically and are grouped in several rings (here: 9) as in the preceding practical example. As is evident from the partially transparent lateral view of the figure, the spherical nubs protrude roughly halfway from the cylindrical inner wall of the basic body 2. As in the preceding practical example, each ring has an identical number of nubs, wherein these are distributed equidistantly over the respective ring, as the front view of FIG. 5 shows. The arrangement of the nubs 3 on the respective rings 4 is such in this case that the adjacent nubs 3 of the rings 4 are arranged on one axis, which runs parallel to the direction of the axial extension (i.e. parallel to the longitudinal axis) of the basic body 2.

FIGS. 6 to 9 show other practical examples of a dual-polarised waveguide with a circular or cylindrical basic body 2 and different configuration variants of the polarisation-preserving filter realised in this, each in a front view.

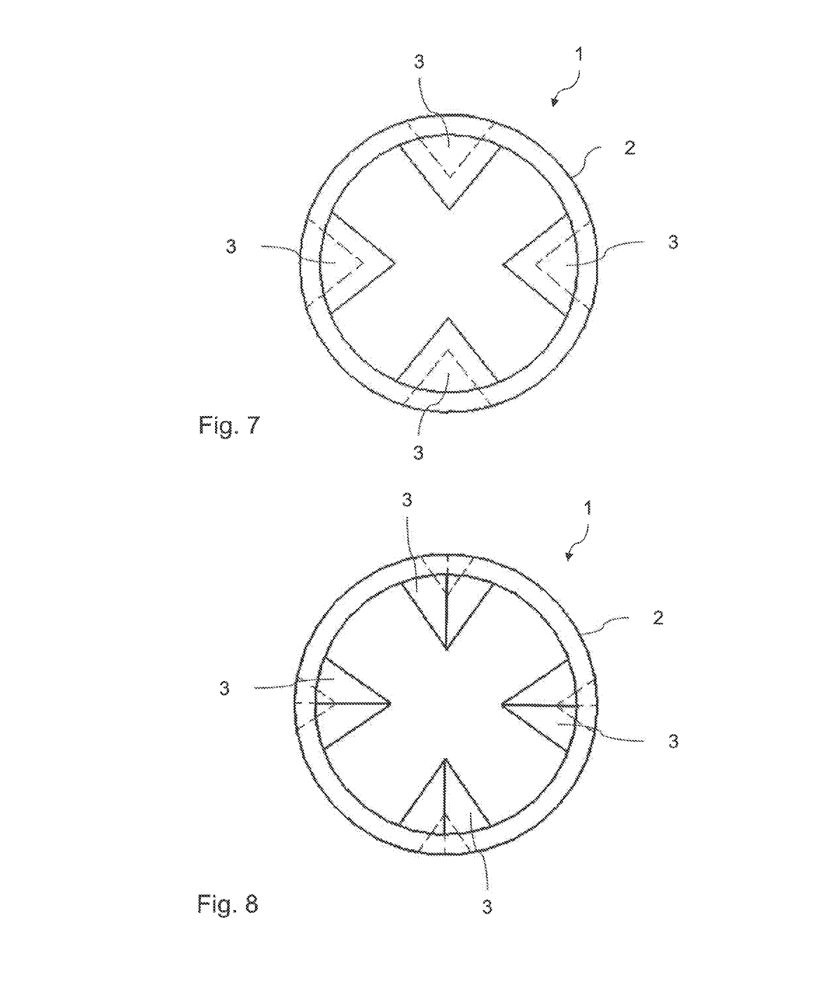

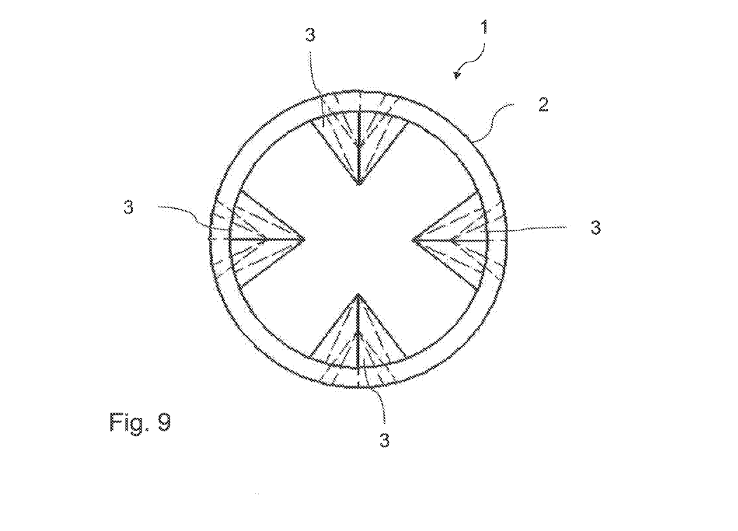

According to the configuration according to FIG. 6, the polarisation-preserving filter has longitudinally elliptical nubs. this practical example, four nubs 3 are arranged on each ring and distributed equidistantly over the circumference of the ring. This means that the nubs 3 are spaced at an angle of 90° from one another and that two nubs come to lie opposite one another respectively. This also applies to the other practical examples in FIGS. 7 to 9. In the practical example according to FIG. 7, the nubs are formed in a cone shape. The practical example according to FIG. 8 shows tetrahedron-shaped nubs. The practical example according to FIG. 9 shows prism-shaped nubs.

Apart from the configuration variants shown here, other combinations are also conceivable. A polarisation-preserving filter can thus be provided, for example, in which nubs with different structural forms are combined with one another. The combination can take place here in any manner. For example, nubs of one structural form may be provided on one or more rings, while nubs of one or more other structural forms are arranged on one or more other rings.

In the practical examples shown in FIGS. 1 to 9, the number of nubs 3 chosen per ring is identical. This is not obligatory. In principle, the number of nubs 3 chosen per ring 4 can be different. Thus one ring 4 can comprise four nubs, for example, an adjacent ring 4 five nubs, and so on. Any combinations are conceivable, in which manner the rings 4 can be realised with different numbers of nubs 3.

In the execution variants shown figuratively here, the dimensions of the nubs 3 are also chosen to be identical in respect of their height and/or their lateral extension (i.e. in an axial direction or transverse to the axial direction). In another configuration, the dimensions of the nubs 3 of one ring or also of adjacent rings may be chosen to be different in respect of their height and/or their lateral extension.

Furthermore, it is not obligatory, as was shown in the figures, that the nubs 3 are distributed evenly over the circumference of a ring 4. On the contrary, the nubs 3 may be distributed differently, e.g. irregularly, over the circumference of a ring 4, so that the spacings and circumferential angles between two nubs 3 of a ring 4 have different values. It is likewise possible that the nubs 3 are distributed evenly on one ring 4, while the nubs 3 on one or more other rings 4 are distributed unevenly.

As is clear in particular from the representation in FIG. 4, the spacings of the rings 4 in an axial direction of the circular or cylindrical basic body 2 are chosen to be identical. In a modification of this, the spacings of the rings 4 may also be chosen to be different in an axial direction of the basic body 2. Here combinations may also occur in which some of the rings 4 have an identical spacing from one another in an axial direction and other rings 4 have another spacing from one another.

A polarisation-preserving filter can be provided hereby with which a first, predetermined frequency band can be transmitted unobstructed and the transmission of a second, predetermined frequency can be blocked. Which frequencies can be transmitted by the polarisation-preserving filter unobstructed and which can be blocked results from the configuration and arrangement of the nubs of the polarisation-preserving filter.

The suitable choice of the number, the dimensioning of the nubs, the number of rings, the spacings of the rings and the even or uneven distribution of the rings can be discovered by simulation or experiments. In particular, which upper and lower frequency the first and second frequency band assumes can be determined by variation of one of said parameters.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A polarisation-preserving filter for a dual-polarised waveguide with a basic body that is circular in cross section, the filter comprising a plurality of nubs arranged in an interior of the basic body, wherein the nubs are grouped in several rings, wherein a first predetermined frequency band can be transmitted unobstructed and transmission of a second predetermined frequency band can be blocked.

2. The filter of claim 1, wherein the nubs have one or more of the following structural forms:
cuboid;
cylinder;
hemisphere;
hemiellipsoid;
prism;
cone or truncated cone;
pyramid or truncated pyramid;
combinations of different geometries.

3. The filter of claim 1, wherein the number of nubs per ring is identical.

4. The filter of claim 3, wherein adjacent nubs of the rings are arranged on an axis parallel to the direction of the axial extension of the basic body.

5. The filter of claim 1, wherein the number of nubs per ring is different.

6. The filter of claim 1, wherein the dimensions of the nubs of a ring are identical in respect of at least one of height and lateral extension.

7. The filter of claim 1, wherein the dimensions of the nubs of a ring are different in respect of at least one of height and lateral extension.

8. The filter of claim 1, wherein the nubs are distributed evenly over the circumference of a ring.

9. The filter of claim 1, wherein the nubs are distributed differently over the circumference of a ring, so that the spacings between two nubs have different values.

10. The filter of claim 1, wherein the spacings of the rings are identical in an axial direction of the basic body.

11. The filter of claim 1, wherein the spacings of the rings are different in an axial direction of the basic body.
